(19) United States
(12) Patent Application Publication
(10) Pub. No.: US 2016/0300236 A1
(43) Pub. Date: Oct. 13, 2016

(54) Systems and Methods for Confirming Identities of Verified Individuals, in Connection With Establishing New Accounts for the Individuals

(71) Applicant: MASTERCARD INTERNATIONAL INCORPORATED, Purchase, NY (US)

(72) Inventors: Juan Wiley, Ossining, NY (US); Stefany Bello Lopez, White Plains, NY (US); Stephen Parento, White Plains, NY (US); Kai Horan, Stamford, CT (US)

(21) Appl. No.: 14/682,397

(22) Filed: Apr. 9, 2015

(51) Int. Cl. G06Q 20/40; H04L 29/06; G06Q 40/02; G06K 9/00

(52) U.S. Cl. CPC G06Q 20/40145; G06K 9/00033; H04L 63/0861; G06Q 40/02

(57) ABSTRACT

Systems and methods are directed toward verifying an identity of an individual and then subsequently confirming the identity of the individual, using biometric data for the individual, in connection with a request by the individual to establish a new account with an account provider. An account is initially generated for the individual when the individual is originally verified, and an identification device is issued to the individual and associated with the account. At this time, a reference biometric from the individual is also stored on the identification device. Then, later, when the individual desires to establish the new account, the individual validates his/her identity at the identification device by providing a biometric matching the reference biometric on the device. And in response, identification data for the individual, from the account generated when the individual was originally verified, is communicated to the account provider for use in establishing the new account.

### FIELD

The present disclosure generally relates to systems and methods for use in confirming identities of previously verified individuals, using biometric data for the individuals, in connection with requests by the individuals to establish new accounts, for example, with account providers, etc.

### BACKGROUND

This section provides background information related to the present disclosure which is not necessarily prior art.

Individuals often open new accounts, at account providers, for banking services, credit services, member benefits, access permits, other services, etc. Typically, in connection with each of the new accounts, the individuals must present appropriate documents to the account providers to verify their identities before the new accounts are opened.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in confirming an identity of an individual, using biometric data for the individual, in connection with a request by the individual to establish a new account at an account provider;

FIG. 2 is a block diagram of an exemplary computing device that may be used in the system of FIG. 1;

FIG. 3 is a block diagram of an exemplary identification device that may be used in the system of FIG. 1; and

FIG. 4 is an exemplary method, suitable for use with the system of FIG. 1, for confirming the identity of the individual in connection with the request by the individual to establish the new account.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Individuals often open new accounts, at account providers, for banking services, credit services (e.g., credit cards, loans, lines of credit, etc.), member benefits, access permits (e.g., building access permits, site access permits, etc.), other services, etc. However, for each of the new accounts, the individuals must verify their identities with the corresponding account providers, typically by presenting identification documents (e.g., birth certificates, social security cards, etc.) to the account providers, before the new accounts are opened. The systems and methods herein allow individuals, whose identities have previously been verified in this manner, to subsequently confirm their identities at the account providers, or at other account providers, using biometric data. Upon such subsequent confirmation, the account providers can then request/use the previously presented information for individuals to open the new accounts, in a streamlined manner, in lieu of collecting the same information separately from the individuals.

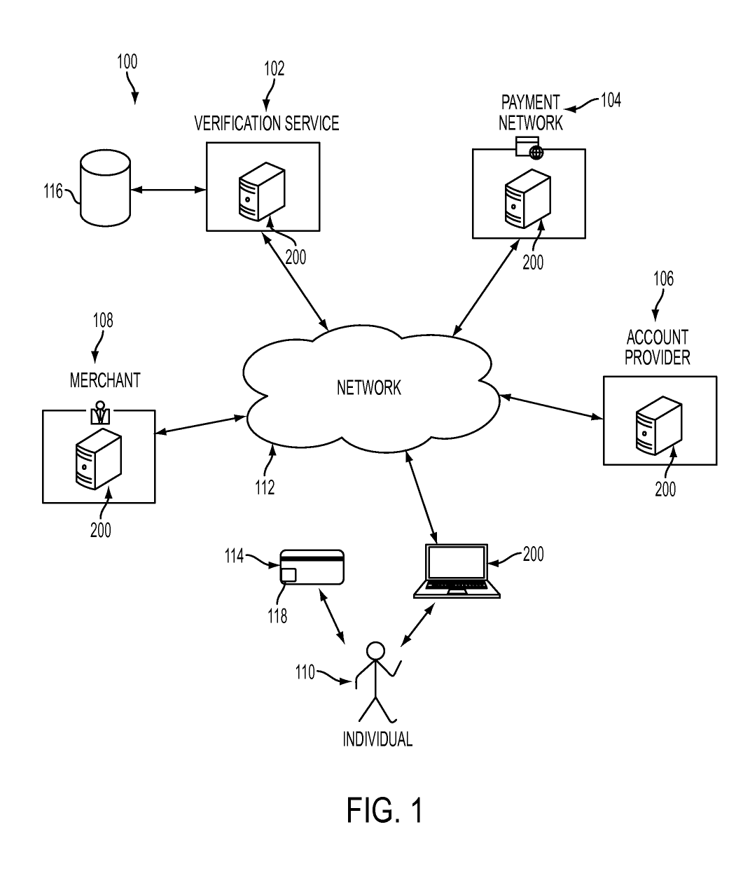

With reference now to the drawings, FIG. 1 illustrates an exemplary system 100, in which one or more aspects of the present disclosure may be implemented. The system 100 is suitable for use in verifying identities of individuals and then subsequently confirming the identities of the individuals, using biometric data for the individuals, in connection with requests by the individuals to establish new accounts, for example, with account providers, etc. Although the components of the system 100 are presented in one arrangement, it should be appreciated that other exemplary embodiments may include the same or different components arranged otherwise, for example, depending on associations between the various components of the system 100, manners of compiling data, manners of collecting biometric data, authorization and/or communication processes for transactions, etc.

As shown in FIG. 1, the illustrated system 100 generally includes a verification service 102, a payment network 104, an account provider 106, and a merchant 108. As will be described, an individual 110 can interact with the verification service 102 to initially, or originally, verify his/her identity. The individual 110 can then subsequently interact with the account provider 106 to open a new account, based on the original verification by the verification service 102.

In the illustrated system 100, each of the verification service 102, the payment network 104, the account provider 106, the merchant 108, and the individual 110 may be implemented in and/or associated with one or more computing devices coupled to network 112. The network 112 may include, without limitation, a wired and/or wireless network, one or more local area network (LAN), wide area network (WAN) (e.g., the Internet, etc.), mobile network, virtual network, other network as described herein, and/or other suitable public and/or private network capable of supporting communication among two or more of the illustrated components, or any combination thereof. In one example, the network 112 includes multiple networks, where different ones of the multiple networks are accessible to different ones of the illustrated components in FIG. 1.

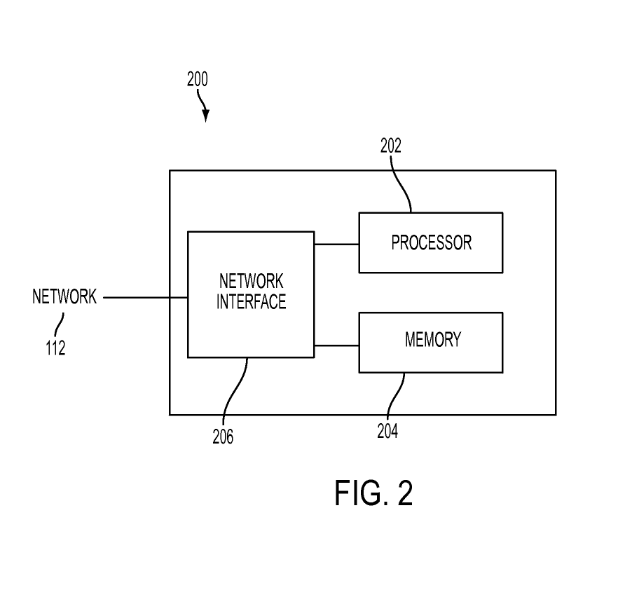

For illustration, the verification service 102, the payment network 104, the account provider 106, the merchant 108, and the individual 110, in the system 100, are described with reference to exemplary computing device 200, illustrated in FIG. 2. However, the system 100 and its components should not be considered to be limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region. Additionally, in some embodiments, each computing device 200 may be coupled to a network (e.g., the Internet, an intranet, a private or public LAN, WAN, mobile network, telecommunication networks, combinations thereof, or other suitable network, etc.) that is part of the network 112, or separate there from.

By way of example, the exemplary computing device 200 may include one or more servers, personal computers, laptops, tablets, PDAs, telephones (e.g., cellular phones, smartphones, other phones, etc.), terminals configured to process identification devices (e.g., point of sale (POS) terminals, etc.), combinations thereof, etc. as appropriate.

As shown in FIG. 2, the illustrated computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may be configured to store, without limitation, data relating to verified individuals, account data for such individuals, transaction data, and/or other types of data suitable for use as described herein, etc. In addition, the memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. Further, computer-readable media may, in some embodiments, be selectively insertable to and/or removable from the computing device 200 to permit access to and/or execution by the processor 202 (although this is not required).

In various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

The illustrated computing device 200 also includes a network interface 206 coupled to the processor 202 and the memory 204. The network interface 206 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

In some exemplary embodiments, the computing device 200 may also include an output device and/or an input device coupled to the processor 202.

The output device, when present in the computing device 200, outputs information and/or data to a user by, for example, displaying, audibilizing, and/or otherwise outputting the information and/or data. In some embodiments, the output device may comprise a display device such that various interfaces (e.g., webpages, etc.) may be displayed at computing device 200, and in particular at the display device, to display such information and/or data, etc. And in some examples, the computing device 200 may cause the interfaces to be displayed at a display device of another computing device, including, for example, a server hosting a website having multiple webpages, etc. With that said, the output device may include, without limitation, a cathode ray tube (CRT), a liquid crystal display (LCD), a light-emitting diode (LED) display, an organic LED (OLED) display, an “electronic ink” display, speakers, combinations thereof, etc. In addition, the output device may include multiple devices.

The input device, when present in the computing device 200, is configured to receive input from a user. The input device may include, without limitation, a keyboard, a pointing device, a mouse, a stylus, a biometric scanner, a touch sensitive panel (e.g., a touch pad or a touch screen, etc.), another computing device, and/or an audio input device. Further, in some exemplary embodiments, a touch screen, such as that included in a tablet, a smartphone, or similar device, may function as both an output device and an input device.

Referring again to FIG. 1, in the illustrated system 100, an identity of the individual 110 is initially verified by the verification service 102. This may be done manually, for example, by a face-to-face meeting between the individual 110 and an individual associated with the verification service 102; or it may be done remotely (e.g., via network 112, etc.). In so doing, the verification service 102 confirms the individual's identity, as appropriate, and ensures that the individual 110 is in fact the actual person the individual 110 claims to be. In particular, the verification service 102 collects data (e.g., identification data, etc.) about the individual 110 and evaluates the data to ensure the identity of the individual 110 is correct. The data may include any desired data relating to the individual 110 and/or to the individual's identity including, without limitation, a name of the individual 110, an address of the individual 110, a date of birth of the individual 110, a social security number of the individual 110, data relating to other accounts associated with the individual 110, data relating to a length of time the verification service 102 has known the individual 110 (e.g., how extensive, time wise, available records are for the individual 110, etc.), etc. Further, the data may be provided to the verification service 102 by the individual 110, via presentation of various documents (e.g., birth certificates, social security cards, passports, etc.) in person or via network 112. Or, the verification service 102 may request the data from other sources or administrators of such data (e.g., government entities, etc.). In some aspects, the verification service 102 may require that the individual 110 contact the verification service 102 (e.g., an enrollment center associated with the verification service 102, etc.), in person, to present the appropriate documents to verify his/her identity.

Once verified, an identification device 114 is issued to the individual 110 by the verification service 102. Biometric data (e.g., fingerprint data, retina data, voice data, etc.) from the individual 110 is recorded onto the identification device 114 as a reference (e.g., as a reference biometric, etc.), by the verification service 102 (or an entity associated with the verification service 102), i.e., the verified individual 110 is matched with the identification device 114. In addition, the verification service 102 stores the data collected about the individual 110 in a data structure 116, in a verification account generated by the verification service 102. The verification account is then associated with the individual 110 and the identification device 114, and corresponding account data is stored on the identification device 114 (e.g., an account number, the individual's name, etc.). In the illustrated system 100, the data structure 116 is illustrated separate from the verification service 102. However, the data structure 116 may be included in the memory 204 of the verification service's computing device 200 in various implementations of the present disclosure.

At this point, it should be appreciated that the verification service 102, in the illustrated system 100, may include any suitable entity that initially, or originally, verifies the identity of the individual 110. For example, the verification service 102 may include an account provider, e.g., a bank, etc., that verifies the individual 110 in connection with opening a new account for the individual 110, a credit issuer that verifies the individual 110 in connection with issuing a new credit card to the individual 110, a government entity that verifies the individual 110 in connection with issuing a government identification to the individual 110 (e.g., a driver's license, etc.) or in connection with enrolling the individual 110 in a government benefit plan, etc. The identification device 114 then issued to the individual 110 can be used as a means for the individual 110 to confirm his/her identity in connection with other identification-necessary activities including, for example, establishing/opening subsequent accounts with the account provider 106 (who, in this embodiment, is different from the verification service 102), etc. As such, in the system 100, initial verification of the individual 110 may be done for a variety of reasons.

Next in the illustrated system 100, when the verified individual 110 desires to initiate a transaction for a new account at the account provider 106 (e.g., a new bank account, a new credit account, a new merchant account, a new access account, another new account, etc.), the individual 110 first confirms his/her identity to the account provider 106 using the identification device 114 (instead of directly providing identification documents to the account provider 106). This is done using a biometric reader 118 (e.g., a fingerprint scanner, a retina scanner, a voice recognition reader, etc.) associated with the identification device 114. In the illustrated embodiment, the biometric reader 118 is provided on the identification device 114, for capturing a biometric from the individual 110. In other exemplary embodiments, the biometric reader 118 may instead be provided with a separate terminal (e.g., a terminal configured to process the identification device 114 (e.g., a POS terminal, etc.), etc.), for example, at the account provider 106, or otherwise associated with the identification device 114. In these embodiments, the terminal then captures the biometric from the individual 110, when the individual 110 uses the identification device 114 at the terminal.

In one aspect of the system 100, after the individual 110 confirms his/her identity using the identification device 114, the individual 110 initiates a verification transaction using the identification device 114 as part of opening the new account. In so doing, the account provider 106 processes (or reads) the identification device 114 at an appropriate terminal (e.g., via a magnetic card swipe, Bluetooth communication, near field communication (NFC), etc.) and communicates, via the network 112, a request to the verification service 102 via the payment network 104 to process the verification transaction (e.g., using the MasterCard® interchange, etc.). The request includes various account data from the identification device 114 relating to the individual 110 (e.g., name, verification account number, etc.) so that the verification service 102 can identify the individual 110 from the request, and an indication of data needed by the account provider 106 to verify the identity of the individual 110 in connection with the new account (which may include at least some of the same data previously used by the verification service 102 to originally verify the identity of the individual 110). In response, the verification service 102 communicates (or distributes) the requested data to the account provider 106, via the payment network 104, along with any other suitable data (e.g., valued customer scores that may help the account provider 106 determine what level/type of account to open, etc.). The account provider 106 can then use the data, received from the verification service 102, to verify the identity of the individual 110 in connection with establishing the new account (in lieu of requesting/collecting the same data again directly from the individual 110).

In another aspect of the system 100 (generally in association with online transactions), when the individual 110 confirms his/her identity using the identification device 114, the identification device 114 will generate a verification (or security) code (e.g., where the identification device 114 includes a security token, a payment token, etc.). The verification code is then communicated by the individual 110, via the computing device 200 and network 112, to the account provider 106 who, then in turn, communicates a request to the verification service 102 via the payment network 104 to process the verification transaction (e.g., using the MasterCard® interchange, etc.). In this aspect of the system 100, the request includes the verification code, the account data for the individual 110 from the identification device 114, and the indication of data needed by the account provider 106 to verify the identity of the individual 110 in connection with the new account. In response, the verification service 102 initially reviews the verification code and, if valid, communicates (or distributes) the requested data (via the payment network 104) to the account provider 106. The account provider 106 can then use the data, received from the verification service 102, as described above.

In various aspects, the data returned by the verification service 102 to the account provider 106, in response to the request, is limited to the data in the possession of the verification service 102. And, depending on the identity of the verification service 102, the content of the data in the possession of the verification service 102 may be different (e.g., depending on the reasons the individual 110 is originally verified, etc.). What's more, the verification service 102 may provide different amounts, types, etc. of data to different account providers, depending on various characteristics of the account providers (e.g., the type of business in which the account provider 106 is involved, the type of relationship the account provider 106 has with the verification service 102, etc.).

Also in the illustrated system 100, the identification device 114 is associated with a payment account for the individual 110 (and payment account data for the individual 110 may be stored on the identification device 114). As such, the identification device 114 can also be used by the individual 110 in purchase transactions to purchase desired goods, services, etc. from the merchant 108. For example, the individual 110 can initiate a purchase transaction by presenting the identification device 114 to the merchant 108 (and, in some cases, entering a personal identification number (PIN) associated with the identification device 114, or capturing a biometric associated with the individual 110), or by entering a verification code from the identification device 114 (e.g., as for a payment token, etc.). In connection with this transaction, the merchant 108 reads the identification device 114 and communicates, via the network 112, an authorization request to the payment network 104, via an acquirer (associated with the merchant 108), to process the purchase transaction (e.g., using the MasterCard® interchange, etc.). The authorization request includes various details of the transaction (e.g., transaction data such as an account number (and any other necessary account data included on the identification device 114), an amount of the transaction, etc.) to help facilitate processing the authorization request. The payment network 104, in turn, passes the authorization request to an issuer (associated with the individual's payment account, and/or who may or may not also be associated with the account provider 106). The issuer then provides an authorization response (e.g., authorizing or declining the request) to the payment network 104, which is provided back through the acquirer to the merchant 108. The purchase transaction with the individual 110 is then completed, or not, by the merchant 108, depending on the authorization response.

The payment account for the individual 110 may be linked to the individual's verification account, such that the verification account also includes account data for processing the purchase transactions performed using the identification device 114. Or, the payment account may be a separate account such that the identification device 114 includes data for both the verification account and the payment account.

With that said, it should be appreciated that the identification device 114 may include any suitable device. For example, the identification device 114 may include a device for use in verifying the identity of the individual 110, such as an identification (ID) card or a security token. Or, the identification device 114 may include a payment device such as a credit card, a debit card, a payment token, or other enabled device that can be used to both verify the identity of the individual 110 and purchase goods, services, etc. In one example, the identification device 114 is an EMV (Europay®, MasterCard® and Visa®) enabled payment device (e.g., a device with an EMV chip, etc.). In other examples, the identification device 114 may include a mobile phone, a tablet computer, a laptop computer, a desktop computer, etc.

In addition, while the biometric reader 118 is integrated with the identification device 114 in the illustrated system 100, in other exemplary embodiments biometric readers may be associated differently with identification devices, for example, removably coupled to the identification devices (e.g., as removable biometric reader dongles, etc.), or associated with terminals configured to process the identification devices. For example, in one embodiment, the biometric reader is provided on a POS terminal at the account provider 106, and the identification device 114 includes a payment card having an EMV chip (and no biometric reader). Here, the individual 110 provides a biometric using the biometric reader on the POS terminal, which then communicates the biometric to the payment card for comparison to a reference biometric on the EMV chip. When the biometrics match, the EMV chip permits a transaction (e.g., a verification transaction, a purchase transaction, combinations thereof, etc.) to be completed, via the payment network 104, using the payment card.

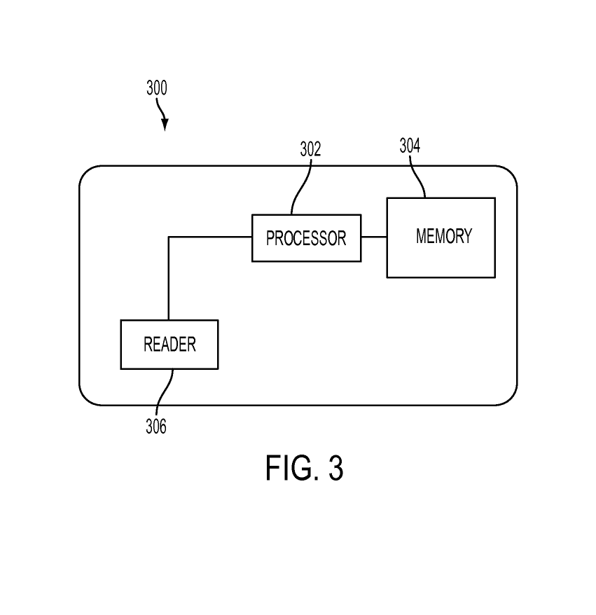

FIG. 3 illustrates an exemplary identification device 300. The identification device 300 may include an ID card, a credit card, a debit card, or other card within the scope of the present disclosure. For purposes of the description herein, the identification device 114 shown in FIG. 1 may be an identification device consistent with the identification device 300. However, it should be appreciated that the identification device 114 of FIG. 1 should not be understood to be limited to the identification device 300, as depicted in FIG. 3, as different identification devices may be used, as described herein, including tokens (e.g., security tokens, payment tokens, etc.), fobs, etc.

The illustrated identification device 300 includes a processor 302 and a memory 304 that is coupled to the processor 302. In addition, a power source (e.g., a capacitor, a battery, etc.) is provided to power the processor 302 and memory 304 on the device 300, or by a terminal, as needed. It should be appreciated that the processor 302 can include one or more suitable processing units, such as described above, and the memory 304 can include any suitable device(s), such as described above, that enable the functions described herein. In various embodiments, the processor 302 and memory 304 are integrated.

The identification device 300 is configured to locally validate, or confirm, an individual 110 (e.g., the individual 110, etc.) using the identification device 300 (e.g., the validation occurs on the identification device 300, etc.). In so doing, the processor 302 and/or the memory 304 of the identification device 300 are programmed (e.g., via processor instructions or code segments, etc.) to set a biometric status identifying that the individual 110 has confirmed his/her identity and enabling use of the identification device 300 in a transaction (e.g., a verification transaction at the account provider 106 or a purchase transaction at the merchant 108, etc.).

For example, the illustrated identification device 300 includes an interface peripheral 306 (e.g., a fingerprint scanner, etc.) disposed on the identification device 300 and configured to receive a biometric from an individual 110 using the identification device 300. The processor 302 is then configured to compare the received biometric, from the peripheral 306, to a biometric previously recorded and stored in the memory 304 on the identification device 300 300, i.e., a reference biometric. The comparison, in this embodiment, takes place on the identification device 300. When the received biometric matches the reference biometric (i.e., is a valid biometric), the processor 302 is then configured to set the biometric status (e.g., a validation bit or digit, etc.) on the identification device 300 to indicate that the identity of the individual 110 has been confirmed.

Then, when the identification device 300 is used in a transaction (e.g., a verification transaction at the account provider 106 or a purchase transaction at the merchant 108, etc.), data (e.g., verification account data, payment account data, etc.) on the identification device 300 is sent with the corresponding request, along with any other desired data provided by the entity submitting the request, through the payment network 104 for processing.

In some embodiments, the biometric status set in the memory 304 of the identification device 300 may only last a short period of time (e.g., 1 minute, 5 minutes, 1 hour, etc.), after which it expires and is reset (e.g., for security purposes, etc.). As such, confirmation of the individual's identity, on the identification device 300, generally takes place at the time, or substantially at the time, of the related transaction. In these embodiments, any suitable timer may be used to track the time period, for example, a resistor/capacitor circuit, a timer, etc. In other embodiments, the biometric status set in the memory 304 may be active/reset based on proximity of the identification device 300 to a terminal configured to process the identification device 300, or based on loss of power to the identification device 300, or based on disassociation of the device 300 from the terminal.

While the illustrated identification device 300 includes a power source configured to provide power to the identification device 300 (e.g., independent of terminals for processing the identification device 300, etc.), it should be appreciated that in other exemplary embodiments identification devices may not include such power sources and may need to be inserted into appropriate terminals to provide power. In such examples, individuals using the identification devices may then confirm their identities when the identification devices are inserted and/or associated with in the terminals.

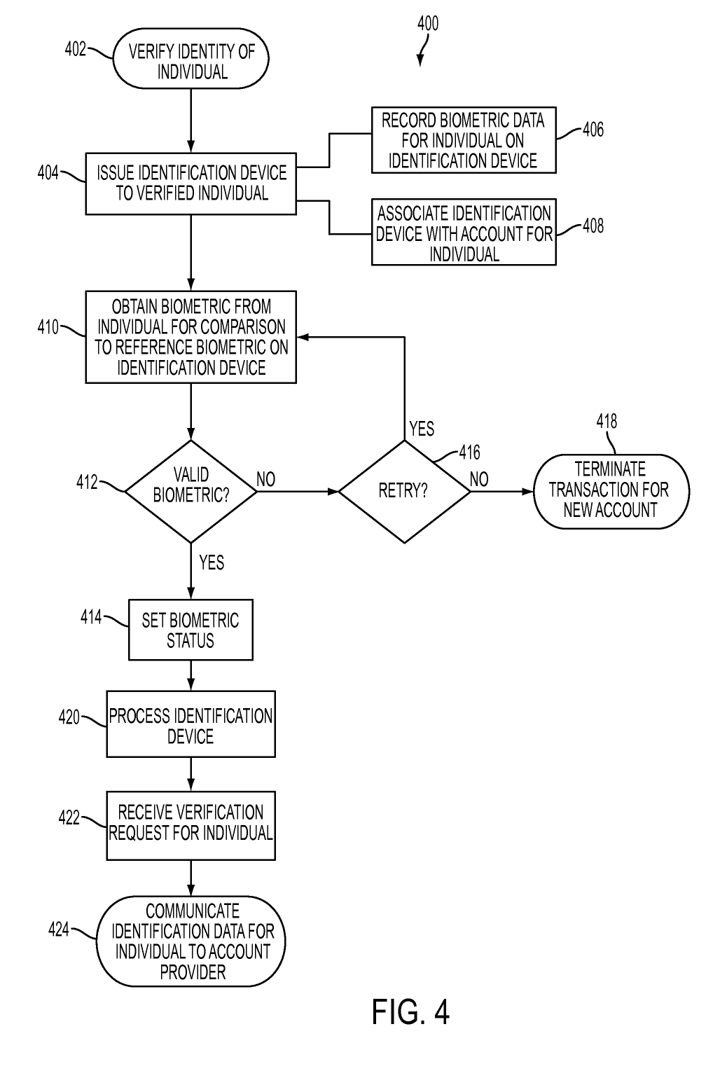

FIG. 4 illustrates an exemplary method 400 for use in verifying the identity of the individual 110 and then subsequently confirming his/her identity, using biometric data for the individual 110, in connection with the request by the individual 110 to establish the new account at the account provider 106. As discussed, the account provider 106 can then request/use the previous data for the individual 110, from the verification service 102, to open the new account (in lieu of requesting/collecting the same data again directly from the individual 110).

The exemplary method 400 is described as implemented in the verification service 102 of the system 100 (e.g., in the computing device 200 of the verification service 102, etc.), with further reference to the payment network 104, the account provider 106, the merchant 108, and the individual 110. In at least some embodiments, the verification service 102 may be included or associated with the payment network 104, or with other entities, shown or not shown in FIG. 1 (e.g., an issuer of payment devices, etc.). Further, for purposes of illustration, the exemplary method 400 is described herein with reference to the computing device 200 and the identification device 300. But, just as the methods herein should not be understood to be limited to the exemplary system 100, or the exemplary computing device 200, or the exemplary identification device 300, the systems and the computing devices and identification devices herein should not be understood to be limited to the exemplary method 400.

As shown in FIG. 4, the verification service 102 initially, or originally, confirms the identity of the individual 110 (i.e., verifies the individual 110), at 402, to ensure that the individual 110 is in fact the actual person the individual 110 claims to be. This may be done in connection with a request, by the individual 110, to establish an account with the verification service 102 (or with an entity associated with the verification service 102, such as another account provider 106, etc.). Or, this may be done in connection with a request by the individual 110 to obtain the identification device 300 from a government agency, etc., for example, as a form of identification. Further, in some embodiments, this may also include a requirement, by the verification service 102, for the individual 110 to contact an office associated with the verification service 102 to perform the confirmation in person by providing suitable documents to verify his/her identity.

Following initial verification of the individual 110, the verification service 102 issues, or assigns, the identification device 300 to the individual 110, at 404. This includes recording and storing biometric data for the individual 110 (i.e., a reference biometric), locally, in the memory 304 on the identification device 300, at 406. As such, the biometric data is specific/particular to the identification device 300 (as opposed to being stored with biometric data for other individuals in a central repository, etc.). As an example, the biometric data may be collected from the individual 110, using a computing device (e.g., a finger print scanner, etc.), and then transferred from the computing device to the memory 304 on the identification device 300. The biometric data provides a basis for comparison, locally on the identification device 300 (e.g., by the processor 302, etc.), of a later collected biometric (e.g., a fingerprint, etc.) when subsequently confirming the identity of the individual 110.

Also in connection with issuing the identification device 300 to the individual 110 at 404, the identification device 300 is associated, by the verification service 102, with the verification account for the individual 110 (in the data structure 116), at 408, so that future action involving the identification device 300 can be correlated to the individual 110 and the individual's verification account. This association can be done at any time including, for example, before the identification device 300 is issued to the individual 110, at about the same time the identification device 300 is issued to the individual 110 (e.g., in parallel with assigning the identification device 300 to the individual 110, etc.), or even after the identification device 300 is issued to the individual 110. Further, account data (e.g., verification account data, payment account data, etc.) for the individual 110 is stored in the memory 304 and/or the processor 302 of the identification device 300, which allows the individual 110 to use the identification device 300 in subsequent transactions (e.g., verification transactions, purchase transactions, etc.).

With continued reference to FIG. 4, in using the identification device 300 to open a new account at the account provider 106, the individual 110 confirms his/her identity to the account provider 106 using the identification device 300. For example, in the illustrated method 400, a biometric is obtained from the individual 110, at 410, using the peripheral 306 of the identification device 300 and compared, at 412, directly on the identification device 300 by the processor 302 to the biometric data (i.e., the reference biometric) previously stored on the identification device 300 in the memory 304. If the received biometric matches the biometric data stored on the identification device 300 (e.g., if the biometric is valid, etc.), at 412, the identification device 300 sets the biometric status for the individual 110 in the memory 304, at 414, to identify the confirmation and to enable use of the identification device 300 in the current verification transaction. However, if the received biometric does not match the biometric data stored on the identification device 300, the individual 110 may retry the process, at 416. Otherwise, the verification transaction is terminated, at 418.

After confirming of the individual's identity at the identification device 300, the identification device 300 is next processed by the account provider 106, at 420, in the verification transaction for the new account. And in connection with the transaction, at 422, a request is communicated to (and received by) the verification service 102, via the processors 202 of the computing devices 200 and via the network 112 (and through the payment network 104), to process the transaction.

In one aspect of the method 400, processing the identification device 300, at 420, includes processing the identification at an appropriate terminal at the account provider 106 as part of the verification transaction. In this aspect of the method 400, the request received by the verification service 102 at 422, in connection with the transaction, includes the account data stored on the identification device 300 for the individual 110, and an indication from the account provider 106 of the data needed to verify the identity of the individual 110 and open the new account for the individual 110 (which may include all or some of the data previously used by the verification service 102 to verify the identity of the individual 110).

In another aspect of the method 400, processing the identification device 300, at 420, includes initially generating a verification code at the identification device 300 after the individual 110 confirms his/her identity (e.g., where the identification device 300 is a token, etc.). In this aspect of the method 400, the request received by the verification service 102 at 422, in connection with the verification transaction, includes the confirmation code, the account data stored on the identification device 300 for the individual 110, and an indication from the account provider 106 of the data needed to verify the identity of the individual 110 and open the new account. Also in this aspect of the method 400, the verification service 102 will validate the confirmation code before taking further action on the request.

Finally, upon receiving the request from the account provider 106, at 422, the verification service 102, via the processor 203, identifies the individual 110 from the account data included in the request (from the data structure 116). The verification service 102 then communicates, via the processor 203, the requested data, at 424, associated with the individual 110 (from the individual's verification account) to the account provider 106 (where it is received at the computing device 200 associated with the account provider 106). The account provider 106 can then use the data, received from the verification service 102, to subsequently verify the identity of the individual 110 and establish the new account (in lieu of requesting/collecting the same data again directly from the individual 110).

Again, and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) collecting identification data from an individual; (b) verifying the individual based on the collected identification data; (c) issuing an identification device to the individual; (d) storing a reference biometric of the individual on the identification device, when the identification device is issued to the individual; (e) setting a biometric status, at the identification device, to indicate a valid biometric when a biometric received to the identification device matches the reference biometric stored on the identification device; (f) resetting the biometric status after an expiration interval; (g) receiving a verification request from an account provider, where the verification request is based on receipt of a valid biometric from an individual at an identification device associated with the individual and a request by the individual to establish a new account with the account provider; and (h) communicating data in response to the verification request from an account associated with the individual to the account provider for use in establishing the new account for the individual.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” or “associated with” another feature, element or layer, it may be directly on, engaged, connected, coupled, or associated with/to the other feature, element or layer, or intervening features, elements or layers may be present. In contrast, when feature, element or layer is referred to as being “directly on,” “directly engaged to,” “directly connected to,” “directly coupled to,” “directly associated with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for use in confirming an identity of a verified individual, using biometric data for the individual, in connection with a request by the individual to establish a new account, the method comprising:
receiving, at a verification service, a verification request from an account provider, the verification request based on receipt of a valid biometric from an individual at an identification device associated with the individual and a request by the individual to establish a new account with the account provider; and
communicating data, via the verification service, in response to the verification request, from an account associated with the individual to the account provider for use in establishing the new account for the individual.

2. The method of claim 1, further comprising:
issuing the identification device to the individual; and
storing a reference biometric of the individual on the identification device, when the identification device is issued to the individual.

3. The method of claim 2, further comprising, prior to issuing the identification device to the individual:
collecting identification data from the individual; and
verifying the individual based on the collected identification data.

4. The method of claim 3, wherein communicating the data to the account provider includes communicating at least some of the collected identification data to the account provider.

5. The method of claim 2, wherein the identification device includes an identification card having a fingerprint scanner; and
wherein the reference biometric includes a fingerprint.

6. The method of claim 2, wherein the identification device includes a token having a fingerprint scanner; and
wherein the reference biometric includes a fingerprint.

7. The method of claim 6, further comprising confirming a security code, from the token, prior to communicating the data to the account provider.

8. The method of claim 1, further comprising:
setting a biometric status, at the identification device, to indicate the valid biometric when a biometric received to the identification device matches a reference biometric stored on the identification device; and
resetting the biometric status after an expiration interval.

9. The method of claim 8, wherein the biometric includes a fingerprint;
wherein the identification device includes a payment card having a fingerprint scanner; and
wherein the account associated with the individual includes a payment account associated with the payment card, the payment card configured to permit one or more purchase transactions when the biometric status is set.

10. The method of claim 1, wherein a transaction request is generated, via the account provider, by the identification device of the individual.

11. The method of claim 1, wherein the data includes identification data for the individual selected from a group consisting of a name, an address, and a date of birth.

12. A system for use in verifying an identity of an individual and then subsequently confirming the identity of the individual, using biometric data for the individual, in connection with a request by the individual to establish a new account with an account provider, the system comprising:
a memory including multiple accounts associated with individuals whose identities have been verified, the accounts including identification data collected from the individuals in connection with verifying the individuals; and
a processor coupled to the memory, the processor configured to execute instructions, stored in the memory, to cause the processor to:
generate, in the memory, an account for an individual who has been verified;
associate an identification device with the account;
store a reference biometric of the individual on the identification device, when the identification device is associated with the account;
retrieve identification data for the individual, from the account in the memory associated with the individual, when a valid biometric is provided by the individual at the identification device in connection with a request by the individual to establish a new account with an account provider; and
communicate at least some of the retrieved identification data for the individual to the account provider;
whereby the account provider can use the communicated identification data to verify the individual, in connection with the new account, in lieu of requiring identification data again from the individual.

13. The system of claim 12, wherein the identification device includes an identification card having a fingerprint scanner; and
wherein the reference biometric includes a fingerprint.

14. The system of claim 12, wherein the identification device includes a token having a fingerprint scanner; and
wherein the reference biometric includes a fingerprint.

15. The system of claim 14, wherein the processor is configured to execute instructions, stored in the memory, to further cause the processor to confirm a security code, from the token, prior to communicating at least some of the retrieved identification data for the individual to the account provider.

16. The system of claim 12, wherein the processor is configured to execute instructions, stored in the memory, to cause the processor to retrieve the identification data for the individual, from the account in the memory associated with the individual, when the valid biometric is provided by the individual at the identification device and in response to a verification request from the account provider, generated by processing the identification device of the individual.

17. The system of claim 12, wherein the biometric includes a fingerprint;
wherein the identification device includes a payment card having a fingerprint scanner; and
wherein the account associated with the individual includes a payment account associated with the payment card, the payment card configured to permit one or more purchase transactions for goods and/or services.

18. A non-transitory computer readable media comprising computer-executable instructions that, when executed by at least one processor, cause the at least one processor to:
retrieve identification data for an individual, from an account associated with the individual, when a valid biometric is provided by the individual at an identification device associated with the individual in connection with a request by the individual to establish a new account with an account provider; and
communicate at least some of the retrieved identification data for the individual to the account provider;
whereby the account provider can use the communicated identification data to verify the individual, in connection with the new account, in lieu of requiring the same identification data again directly from the individual.

19. The non-transitory computer readable media of claim 18, wherein the biometric includes a fingerprint;
wherein the identification device includes a payment card having a fingerprint scanner; and
wherein the account associated with the individual includes a payment account associated with the payment card, whereby the payment card is configured to be used by the individual in connection with purchase transactions for goods and/or services.

20. The non-transitory computer readable media of claim 18, wherein the identification device includes a token having a fingerprint scanner;
wherein the reference biometric includes a fingerprint; and
wherein the computer-executable instructions, when executed by the at least one processor, cause the at least one processor to confirm a security code, from the token, prior to communicating at least some of the retrieved identification data for the individual to the account provider.
